(19) United States
(12) Patent Application Publication
(10) Pub. No.: US 2025/0140901 A1
(43) Pub. Date: May 1, 2025

(54) BATTERY ELECTRODE

(71) Applicant: GM GLOBAL TECHNOLOGY OPERATIONS LLC, Detroit, MI (US)

(72) Inventors: Yifan Zhao, Troy, MI (US); Yun-Yu Lai, Clawson, MI (US); Thomas A. Yersak, Royal Oak, MI (US); Fang Dai, Troy, MI (US); Zhe Li, Shanghai (CN)

(21) Appl. No.: 18/533,387

(22) Filed: Dec. 8, 2023

(30) Foreign Application Priority Data
Oct. 31, 2023 (CN) 202311439956.7

(51) Int. Cl. H01M 10/056; H01M 4/02; H01M 4/58

(52) U.S. Cl. CPC H01M 10/056; H01M 4/58; H01M 2004/028; H01M 2300/0028; H01M 2300/0068

(57) ABSTRACT

An electrochemical cell including an electrode including a sulfuric conversion electroactive material, and a solid state electrolyte comprising an oxysulfide; a liquid electrolyte; a separator; and a negative electrode.

### CROSS-REFERENCE TO RELATED APPLICATIONS

This application claims priority to Chinese Patent Application No. 202311439956.7, filed Oct. 31, 2023, and all the benefits accruing therefrom under 35 U.S.C. § 119, the contents of which in its entirety are herein incorporated by reference.

### INTRODUCTION

The present disclosure relates to electrodes, for example sulfur-containing electrodes, for use in lithium-ion electrochemical cells and methods of forming the same.

Advanced energy storage devices and systems are in demand to satisfy energy and/or power requirements for a variety of products, including automotive products such as start-stop systems (e.g., 12 volt (V) start-stop systems), battery-assisted systems, Hybrid Electric Vehicles (“HEVs”), and Electric Vehicles (“EVs”). Typical lithium-ion and lithium-sulfur batteries include at least two electrodes and an electrolyte and/or separator. One of the two electrodes serves as a positive electrode or cathode and the other electrode serves as a negative electrode or anode. Each of the electrodes is connected to a current collector (typically a metal, such as copper for the anode and aluminum for the cathode). A separator and/or electrolyte may be disposed between the negative and positive electrodes. The electrolyte is suitable for conducting lithium ions between the electrodes and, like the two electrodes, may be in various instances solid and/or liquid form and/or a hybrid thereof. In instances of solid state batteries, which include solid state electrodes and a solid state electrolyte, the solid state electrolyte may physically separate the electrodes so that a distinct separator is not required.

Lithium-sulfur batteries may include cathodes having sulfur-based electroactive materials, for example, elemental sulfur(S) and/or Li₂Sₓ where 1≤x≤8. Such cathodes often include one or more electroactive material layers, including for example a plurality of electroactive material particles, disposed on or near one or more surfaces of a current collector.

It would be desirable to develop cathodes that enable lower cell impedance, increased active material utilization, and increased cathode ion transport and kinetics, and methods of making the same, for an electrochemical cell that can address these challenges, for example, methods and materials that may be readily integrated into common manufacturing processes.

### SUMMARY

In one exemplary embodiment, the present disclosure provides an electrochemical cell. The electrochemical cell may include an electrode including a sulfuric conversion electroactive material, and a solid state electrolyte including an oxysulfide: a liquid electrolyte: a separator; and a negative electrode.

In addition to one or more of the features described herein, the solid state electrolyte may include 75Li₂S-20P₂S₅-5P₂O₅; and the liquid electrolyte may include lithium bis(trifluoromethanesulfonyl)imide salt and triglyme (G3) (Li(G3)TFSI), or lithium bis(trifluoromethanesulfonyl)imide salt and tetraglyme (G4) (Li(G4)TFSI), wherein a molar ratio of salt to solvent is 1:0.8.

In another exemplary embodiment, the liquid electrolyte may include a limited solvating liquid electrolyte.

In yet another exemplary embodiment, the separator may include a porous polymer separator.

In yet another exemplary embodiment, the sulfuric conversion electroactive material may include S, S₈, Li₂S₈, Li₂S₆, Li₂S₄, Li₂S₂, Li₂S, Fe₂S, or a combination thereof.

In yet another exemplary embodiment, the solid state electrolyte may include yLi₂S·(100-y-x)P₂S₅·xP₂O₅, wherein y is in a range from 70 molar percentage to 80 molar percentage and x is in a range from 0.5 molar percentage to 10 molar percentage.

In yet another exemplary embodiment, the solid state electrolyte may include Li₁₀MP₂S₁₂, wherein M is Si, Ge, or Sn; Li₆PS₅Cl; Li_{3.25}Ge_{0.25}P_{0.75}S₄; Li₄GeS₄; a Li₂S—P₂S₅ system: a Li₂S—SnS₂ system; a Li₂S—SiS₂ system; a Li₂S—GeS₂ system; a Li₂S—B₂S₃ system; a Li₂S—Ga₂S₅ system; a Li₂S—P₂S₃ system; a Li₂S—Al₂S₃ system; Li_{3.4}Si_{0.4}P_{0.6}S₄; Li₁₀GeP₂S_{11.7}O_{0.3}; a lithium argyrodite Li₆PS₅X where X is Cl, Br, or I; a Li₂O—Li₂S—P₂S₅ system; a Li₂S—P₂S₅—P₂O₅ system; a Li₂S—P₂S₅—GeS₂ system; a Li₂S—P₂S₅—LiX system where X is F, Cl, Br, or I; a Li₂S—As₂S₅—SnS₂ system; a Li₂S—P₂S₅—Al₂S₃ system; a Li₂S—LiX—SiS₂ system where X is or F, Cl, Br, and I; 0.4LiI·0.6Li₄SnS₄; Li₁₁Si₂PS₁₂; a Li₂O—Li₂S—P₂S₅—P₂O₅ system; Li_{9.54}Si_{1.74}P_{1.44}S_{11.7}Cl_{0.3}; Li_{9.6}P₃S₁₂; Li₂P₃S₁₁; Li₉P₃S₉O₃; Li_{10.35}Ge_{1.35}P_{1.65}S₁₂; Li_{10.35}Si_{1.35}P_{1.65}S₁₂; Li_{9.81}Sn_{0.81}P_{2.1.9}S₁₂; Li₁₀(Si_{0.5}Ge_{0.5})P₂S₁₂; Li₁₀(Ge_{0.5}Sne_{0.5})P₂S₁₂; Li₁₀(Si_{0.5}Sn_{0.5})P₂S₁₂; Li₂P_{2.9}Mn_{0.1}S_{10.7}I_{0.3}; Li_{3.833}Sn_{0.833}As_{0.166}S₄; LiI—Li₄SnS₄; Li₄SnS₄; Li_{10.35}[Sn_{0.27}Si_{1.08}]P_{1.65}S₁₂; or a combination thereof.

In yet another exemplary embodiment, the liquid electrolyte may include a solvate ionic liquid including lithium bis(trifluoromethanesulfonyl)imide salt and diglyme (G2) (Li(G2)TFSI), lithium bis(trifluoromethanesulfonyl)imide salt and triglyme (G3) (Li(G3)TFSI), lithium bis(trifluoromethanesulfonyl)imide salt and tetraglyme (G4) (Li(G4)TFSI), lithium bis(fluorosulfonyl)imide salt and diglyme (G2) (Li(G2)FSI), lithium bis(fluorosulfonyl)imide salt and triglyme (G3) (Li(G3)FSI), lithium bis(fluorosulfonyl)imide salt and tetraglyme (G4) (Li(G4)FSI), lithium bis(pentafluoroethanesulfonyl)imide salt and diglyme (G2) ([Li(G2)]BETI), lithium bis(pentafluoroethanesulfonyl)imide salt and triglyme (G3) ([Li(G3)]BETI), lithium bis(pentafluoroethanesulfonyl)imide salt and tetraglyme (G4) ([Li(G4)]BETI), lithium cyano (trifluoromethanesulfonyl)imide salt and diglyme (G2) ([Li(G2)]CTFSI), lithium cyano (trifluoromethanesulfonyl)imide salt and triglyme (G3) ([Li(G3)]CTFSI), lithium cyano (trifluoromethanesulfonyl)imide salt and tetraglyme (G4) ([Li(G4)]CTFSI), lithium perchlorate salt and diglyme (G2) ([Li(G2)]ClO₄), lithium perchlorate salt and triglyme (G3) ([Li(G3)]ClO₄), lithium perchlorate salt and tetraglyme (G4) ([Li(G4)]ClO₄), lithium tetrafluoroborate salt and diglyme (G2) ([Li(G2)]BF₄), lithium tetrafluoroborate salt and triglyme (G3) ([Li(G3)]BF₄), lithium tetrafluoroborate salt and tetraglyme (G4) ([Li(G4)]BF₄), lithium nitrate salt and diglyme (G2) ([Li(G2)]NO₃), lithium nitrate salt and triglyme (G3) ([Li(G3)]NO₃), lithium nitrate salt and tetraglyme (G4) ([Li(G4)]NO₃), lithium triflate salt and diglyme (G2) ([Li(G2)]OTf), lithium triflate salt and triglyme (G3) ([Li(G3)]OTf), lithium triflate salt and tetraglyme (G4) ([Li(G4)]OTf), lithium trifluoroacetate salt and diglyme (G2) ([Li(G2)]TFA), lithium trifluoroacetate salt and triglyme (G3) ([Li(G3)]TFA), lithium trifluoroacetate salt and tetraglyme (G4) ([Li(G4)]TFA), or a combination thereof.

In yet another exemplary embodiment, the liquid electrolyte may include an ionic liquid electrolyte including 1-ethyl-3-methylimidazolium bis(trifluoromethylsulfonyl)imide (EMIM-TFSI), 1-butyl-3-methylimidazolium bis(trifluoromethylsulfonyl)imide (BMIM-TFSI), N-propyl-N-methylpyrrolidinium bis(trifluoromethanesulfonyl)imide (PYR13TFSI), 1-butyl-1-methylpyrrolidinium bis(trifluoromethylsulfonyl)imide (PYR14TFSI), 1-ethyl-3-methylimidazolium bis(fluorosulfonyl)imide (EMIM-FSI), 1-butyl-3-methylimidazolium bis(fluorosulfonyl)imide (BMIM-FSI), N-propyl-N-methylpyrrolidinium bis(fluorosulfonyl)imide (PYR13-FSI), 1-butyl-1-methylpyrrolidinium bis(fluorosulfonyl)imide (PYR14-FSI), or a combination thereof.

In yet another exemplary embodiment, the liquid electrolyte may include an organic solvent including ethylene carbonate (EC), propylene carbonate (PC), butylene carbonate (BC), fluoroethylene carbonate (FEC), dimethyl carbonate (DMC), diethyl carbonate (DEC), ethyl methyl carbonate (EMC), methyl formate, methyl acetate, methyl propionate, γ-butyrolactone, γ-valerolactone, 1,1,2,2-tetrafluoroethyl-2,2,3,3-tetrafluoropropyl ether (TTE), bis(2,2,2-trifluoroethyl) carbonate (ETFEC), bis(2,2,2-trifluoroethyl) ether (BTFE), 1,1,2,3,3,3-hexafluoropropyl-2,2,2-trifluoroethyl ether, methyl 3,3,3-trifluoropionate, or ethyl trifluoroacetate, tris(2,2,2-trifluoroethyl) orthoformate (TFEO), bis(2,2,2-trifluoroethyl) carbonate) (BTC), methyl 2,2,2-trifluoroethyl carbonate (FEMC), 1,2-dimethoxyethane (DME), 1,2-diethoxyethane, ethoxymethoxyethane, tetrahydrofuran, 2-methyltetrahydrofuran, 1,3-dioxolane (DOL), sulfolane, diglyme (G2), triglyme (G3), tetraglyme (G4), or a combination thereof; and a lithium salt including lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium difluorooxalatoborate (LiBF₂(C₂O₄)) (LiODFB), lithium tetraphenylborate (LiB(C₆H₅)₄), lithium bis-(oxalate) borate (LiB(C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LiFSI), lithium fluoroalkylphosphate (LiFAP) (Li₃O₄P), or a combination thereof.

In yet another exemplary embodiment, the sulfuric conversion electroactive material may include a sulfur-carbon composite, a Li₂S—C composite, sulfurized polyacrylonitrile, or a combination thereof.

In yet another exemplary embodiment, the electrode may further include an electrically conductive material including carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, or a combination thereof.

In yet another exemplary embodiment, the electrode may further include a binder including styrene-butadiene rubber (SBR), hydrogenated nitrile rubber (HNBR), poly(vinylidene fluoride) (PVDF), poly(vinylidene fluoride-co-hexafluoropropylene) (PVDF-HFP), polytetrafluoroethylene (PTFE), poly(tetrafluoroethylene-co-perfluoro (3-oxa-4-pentenesulfonic acid)) lithium salt, sodium carboxymethyl cellulose (CMC), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), or a combination thereof.

In yet another exemplary embodiment, the electrode may include, based on a total weight of the electrode 40 to 70 weight percent of the sulfuric conversion electroactive material: 5 to 30 weight percent of the solid state electrolyte; 0.1 to 20 weight percent of the binder; and 0.1 to 30 weight percent of an electrically conductive material.

In yet another exemplary embodiment, the negative electrode may include lithium, graphite, graphene, hard carbon, soft carbon, carbon nanotubes, silicon, silicon-containing alloys, tin-containing alloys, or a combination thereof.

In one exemplary embodiment, the present disclosure provides an electrochemical cell. The electrochemical cell may include an electrode including a sulfuric conversion electroactive material, and an oxide solid state electrolyte: a liquid electrolyte: a separator; and a negative electrode.

In addition to one or more of the features described herein, the liquid electrolyte may include a limited solvating liquid electrolyte including a solvate ionic liquid.

In another exemplary embodiment, the oxide solid state electrolyte may include Li₁₊ₓAlₓGe₂₋ₓ(PO₄)₃ (LAGP) (where 0≤x≤2), Li₇La₃Zr₂O₁₂(LLZO), or Li₁₊ₓAlₓTi₂₋ₓ(PO₄)₃ (LATP) (where 0≤x≤2); and the liquid electrolyte may include lithium bis(trifluoromethanesulfonyl)imide salt and triglyme (G3) (Li(G3)TFSI), or lithium bis(trifluoromethanesulfonyl)imide salt and tetraglyme (G4) (Li(G4)TFSI), wherein a molar ratio of salt to solvent is 1:0.8.

In one exemplary embodiment, the present disclosure provides an electrochemical cell. The electrochemical cell may include an electrode including a sulfuric conversion electroactive material, and a solid state electrolyte including a sulfide: a liquid electrolyte: a separator; and a negative electrode.

In addition to one or more of the features described herein, the liquid electrolyte may include a limited solvating liquid electrolyte including a solvate ionic liquid.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 schematically shows a disassembled isometric view of a prismatic battery cell that includes an anode, an electrolytic material, a separator, and a cathode, in accordance with the disclosure;

FIG. 2 schematically illustrates a cutaway side view of an embodiment of a cathode:

FIG. 3 schematically illustrates elements of a process for forming a cathode for a battery cell:

FIG. 4 is a graphical illustration demonstrating electrochemical performance of Comparative Example 1; and

FIG. 5 is a graphical illustration demonstrating electrochemical performance of Example 1.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, an electrode for batteries, for example, lithium-sulfur batteries, and methods of forming and using the same are disclosed. Such batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. The present disclosure provides a rechargeable lithium-ion battery that exhibits-lower cell impedance, increased active material utilization, and increased cathode ion transport and kinetics.

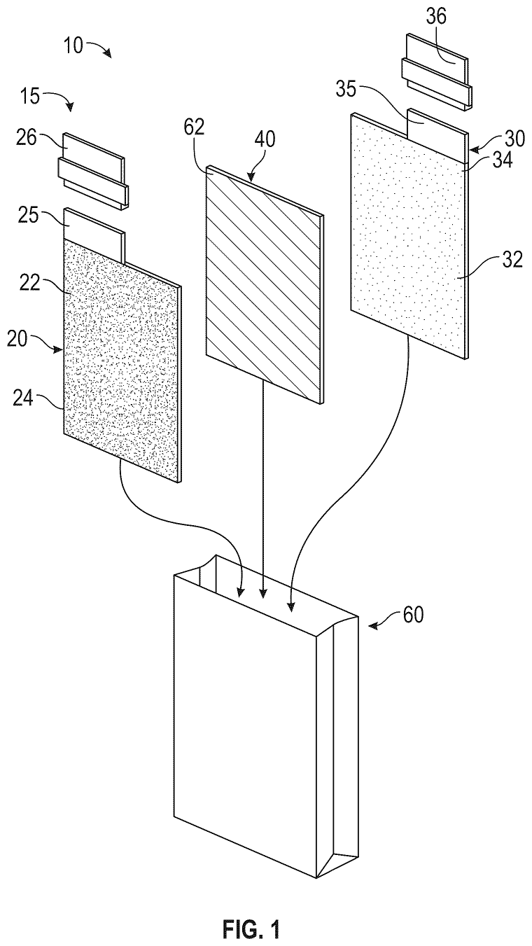

Referring to the drawings, wherein like reference numerals correspond to like or similar components throughout the several Figures, FIG. 1 schematically illustrates an embodiment of a prismatically-shaped lithium ion battery cell 10 that includes an electrode pair 15 having a cathode 20, a separator 40, and an anode 30 that are arranged in a stack and sealed in a flexible pouch 60 containing an electrolytic material 62. In an embodiment of the battery cell, a reference electrode may be arranged between the anode and the cathode. A first, positive battery cell tab 26 and a second, negative battery cell tab 36 protrude from the flexible pouch 60. The terms “anode” and “negative electrode” are used interchangeably. The terms “cathode” and “positive electrode” are used interchangeably. A single electrode pair 15 including an arrangement of the cathode 20, separator 40, and anode 30 is illustrated. It is appreciated that multiple electrode pairs 15 may be arranged and electrically connected in the flexible pouch 60, depending upon the application of the battery cell 10.

The cathode 20 includes a sulfuric conversion electroactive material 22 that is arranged on a cathode current collector 24, and the cathode current collector 24 may have a foil portion 25 that extends from the sulfuric conversion electroactive material 22 to form the second battery cell tab 26.

The anode 30 includes a second electroactive material 32 that is arranged on an anode current collector 34. The anode current collector 34 may be a metallic substrate with a foil portion 35 that extends from the second electroactive material 32 to form the first battery cell tab 36.

The cathode and anode current collectors 24, 34 may be metallic plate-shaped elements that contact respective first and second electroactive materials 22, 32 over an appreciable interfacial surface area. The purpose of the cathode and anode current collectors 24, 34 is to exchange free electrons with respective first and second electroactive materials 22, 32 during discharging and charging.

The cathode current collector 24 may be a metallic substrate in the form of a planar sheet that is fabricated from aluminum or an aluminum alloy, and may have a thickness of, for example, 0.02 millimeters (mm). The separator 40 is arranged between the cathode 20 and the anode 30 to physically separate and electrically isolate the anode 30 from the cathode 20.

The anode current collector 34 may be a flat, plate-shaped metallic substrate in the form of a rectangular planar sheet in an embodiment. In an embodiment, the anode current collector 34 may be arranged as a planar sheet having a non-rectangular shape, a coiled configuration, a cylindrical configuration, or another configuration.

The anode current collector 34 may be fabricated from one of copper, copper alloy, stainless steel, nickel, etc., or another material that does not alloy with lithium. In an embodiment, the anode current collector 34 may have a thickness of, for example, 0.02 mm. The second electroactive material 32 is present in a second electroactive material layer that may be applied onto one or both surfaces of the anode current collector 34.

The cathode current collector 24, the anode current collector 34, or a combination thereof may include stainless steel, aluminum, nickel, iron, titanium, copper, tin, a suitable electrically conductive material, or a combination thereof. The cathode current collector 24, the anode current collector 34, or a combination thereof may be a cladded foil, for example, where one side (e.g., the first side or the second side) of the current collector 24, 34 includes one metal (e.g., first metal) and another side (e.g., the other side of the first side or the second side) of the current collector 24, 34 includes another metal (e.g., second metal). The cladded foil may include, for example, aluminum-copper (AlCu), nickel-copper (NiCu), stainless steel-copper (SS—Cu), aluminum-nickel (Al—Ni), aluminum-stainless steel (Al—SS), and nickel-stainless steel (Ni—SS). The cathode current collector 24, the anode current collector 34, or a combination thereof may be precoated, such as graphene or carbon-coated aluminum current collectors. The cathode current collector 24, the anode current collector 34, or a combination thereof may be in the form of a foil, slit mesh, woven mesh, or a combination thereof.

The electrolytic material 62 that conducts lithium ions may be contained within the separator 40 and may be exposed to each of the cathode 20 and the anode 30 to permit lithium ions to move between the cathode 20 and the anode 30. Lithium ions may be stripped from the anode 30 during discharge, or from the cathode 20 during charge give up electrons that flow through the current collectors 34 and 24, respectively, through an external circuit connected either to a load or a charger, and then to the opposite current collectors (24 and 34) and electrodes (20 and 30) where they reduce lithium ions as they are being intercalated.

The cathode 20 and the anode 30 are each fabricated as electrode materials that are able to deposit and strip the lithium ions (on an anode), or intercalate and de-intercalate (on a cathode). The electrode materials of the cathode 20 and the anode 30 are formulated to store lithium at different electrochemical potentials relative to a common reference electrode (e.g., lithium). In the construct of the electrode pair 15, the anode 30 stores deposited or plated lithium at a lower electrochemical potential (i.e., a higher energy state) than the cathode 20 such that an electrochemical potential difference exists between the cathode 20 and the anode 30 when the anode 30 is lithiated. The electrochemical potential difference for each battery cell 10 may result in a charging voltage in the range of 3 V to 5 V and nominal open circuit voltage in the range of 2.9 V to 4.2 V, which may permit the reversible transfer of lithium ions between the cathode 20 and the anode 30 either spontaneously (discharge phase) or through the application of an external voltage (charge phase) during operational cycling. The thickness of the anode 30 is between 10 μm and 20 μm in an embodiment.

Disclosed are a positive electrode including a sulfuric conversion electroactive material and a solid state electrolyte and an electrochemical cell including the electrode and a limited solvating liquid electrolyte. The liquid electrolyte may be a limited solvating liquid electrolyte that may help prevent dissolution of sulfur and sulfur reaction may be catalyzed by including the solid state electrolyte in the electrode.

As used herein, the phrase conversion electroactive material refers to a crystalline structure of cathode changes when the electroactive material takes up Li⁺. Bonds may be broken and new compounds may be formed. An example of such a material is Li₂S. In contrast, the crystalline structure of an insertion electroactive material, also known as an intercalate electroactive material, does not change when the electroactive material takes up Li⁺. An example of such a material is nickel-cobalt-manganese (NCM).

As used herein, the phrase “limited solvating liquid electrolyte” refers to an electrolyte that does not dissolve a sulfur cathode. An example of a limited solvating liquid electrolyte is Li[G3]TFSI or Li[G4]_{0.8}TFSI. In contrast, a high solvating electrolyte” refers to an electrolyte that may dissolve a sulfur cathode, such as, for example, 1 molar (moles per liter, M) LiTFSI in DME:DOL.

The first electroactive material layer 23 of the cathode 20 may include a sulfuric conversion electroactive material 22, a solid state electrolyte including an oxide, a sulfide, or an oxysulfide 28, and a first binder 29. The cathode may include, based on a total weight of the cathode, 30 wt. % to 70 wt. %, for example, 40 wt. % to 70 wt. %, of the sulfuric conversion electroactive material, 5 wt. % to 50 wt. %, for example, 5 wt. % to 30 wt. %, of the solid state electrolyte, 0.1 wt. % to 30 wt. %, for example, 0.1 wt. % to 20 wt. %, of a first electrically conductive material, and 0.1 wt. % to 20 wt. % of a first binder.

The disclosed solid state electrolyte of the electrode forms a stationary (e.g., “bound”) or immobile portion of a solid structure of the cathode in combination with the sulfuric conversion electroactive material. The first binder may structurally fortify the sulfuric conversion electroactive material and the solid state electrolyte. An electrolytic material that may be present inside pores of the cathode, as described further herein, is not a static feature of the cathode. The electrode may have a porosity of 10 to 60%.

The cathode may be in the form of a layer having a thickness from 1 μm to 1,000 μm, for example, from 5 μm to 400 μm or from 10 μm to 300 μm. The cathode may be defined by a plurality of sulfuric conversion electroactive material, for example, including the sulfuric conversion electroactive material. The sulfuric conversion electroactive material may have an average particle diameter from 0.01 μm to 50 μm, for example, from 1 μm to 20 μm.

The sulfuric conversion electroactive material 22 may be, for example, S, S₈, Li₂S₈, Li₂S₆, Li₂S₄, Li₂S₂, Li₂S, Fe₂S, or a combination thereof. The sulfuric conversion electroactive material may include a sulfur-carbon composite (e.g., a sulfuric conversion electroactive material loaded in carbon), a Li₂S—C composite, sulfurized polyacrylonitrile, or a combination thereof. The sulfuric conversion electroactive material should sufficiently undergo lithiation and delithiation while functioning as a positive terminal of the battery cell.

The sulfuric conversion electroactive material may be present in the cathode in an amount greater than or equal to 50 wt. %, greater than or equal to 60 wt. %, greater than or equal to 70 wt. %, greater than or equal to 80 wt. %, greater than or equal to 90 wt. %, greater than or equal to 95 wt. %, based on total weight of the cathode; or from 50 wt. % to 99 wt. %, 70 wt. % to 99 wt. %, or 90 wt. % to 99 wt. %, based on total weight of the cathode. The first electroactive material may include a sulfur-carbon composite, for example, in an amount of 50 wt. % to 95 wt. %, based on total weight of the cathode, and a weight ratio of sulfur to carbon in the sulfur-carbon composite may be from 1:1 to 9:1.

The solid state electrolyte 28 may include yLi₂S·(100yx)P₂S₅·xP₂O₅, wherein y is in a range from 70 molar percentage to 80 molar percentage and x is in a range from 0.5 molar percentage to 10 molar percentage. The solid state electrolyte 28 may include Li₁₀MP₂S₁₂, wherein M is Si, Ge, or Sn; Li₆PS₅Cl; Li_{3.25}Ge_{0.25}P_{0.75}S₄; Li₄GeS₄; a Li₂S—P₂S₅ system; a Li₂S—SnS₂ system; a Li₂S—SiS₂ system; a Li₂S—GeS₂ system; a Li₂S—B₂S₃ system; a Li₂S—Ga₂S; system; a Li₂S—P₂S₃ system; a Li₂S—Al₂S₃ system; Li_{3.4}Si_{0.4}P_{0.6}S₄; Li₁₀GeP₂S_{11.7}O_{0.3}; a lithium argyrodite Li₆PS₅X where X is Cl, Br, or I; a Li₂O—Li₂S—P₂S₅ system; a Li₂S—P₂S₅—P₂O₅ system; a Li₂S—P₂S₅—GeS₂ system; a Li₂S—P₂S₅—LiX system where X is F, Cl, Br, or I; a Li₂S—As₂S₅—SnS₂ system; a Li₂S—P₂S₅—Al₂S₃ system; a Li₂S—LiX—SiS₂ system where X is or F, Cl, Br, and I; 0.4LiI·0.6Li₄SnS₄; Li₁₁Si₂PS₁₂; a Li₂O—Li₂S—P₂S₅—P₂O₅ system; Li_{9.54}Si_{1.74}P_{1.44}S_{11.7}Cl_{0.3}; Li_{9.6}P₃S₁₂; Li₂P₃S₁₁; Li₉P₃S₉O₃; Li_{10.35}Ge_{1.35}P_{1.65}S₁₂; Li_{10.35}Si_{1.35}P_{1.65}S₁₂; Li_{9.81}Sn_{0.81}P_{2.1.9}S₁₂; Li₁₀(Si_{0.5}Ge_{0.5})P₂S₁₂; Li₁₀(Ge_{0.5}Sne_{0.5})P₂S₁₂; Li₁₀(Si_{0.5}Sn_{0.5})P₂S₁₂; Li₂P_{2.9}Mn_{0.1}S_{10.7}I_{0.3}; Li_{3.833}Sn_{0.833}As_{0.166}S₄; LiI—Li₄SnS₄; Li₄SnS₄; Li_{10.35}[Sn_{0.27}Si_{1.08}]P_{1.65}S₁₂; or a combination thereof.

The limited solvating liquid electrolyte may include a solvate ionic liquid, for example, lithium bis(trifluoromethanesulfonyl)imide salt and diglyme (G2) (Li(G2)TFSI), lithium bis(trifluoromethanesulfonyl)imide salt and triglyme (G3) (Li(G3)TFSI), lithium bis(trifluoromethanesulfonyl)imide salt and tetraglyme (G4) (Li(G4)TFSI), lithium bis(fluorosulfonyl)imide salt and diglyme (G2) (Li(G2)FSI), lithium bis(fluorosulfonyl)imide salt and triglyme (G3) (Li(G3)FSI), lithium bis(fluorosulfonyl)imide salt and tetraglyme (G4) (Li(G4)FSI), lithium bis(pentafluoroethanesulfonyl)imide salt and diglyme (G2) ([Li(G2)]BETI), lithium bis(pentafluoroethanesulfonyl)imide salt and triglyme (G3) ([Li(G3)]BETI), lithium bis(pentafluoroethanesulfonyl)imide salt and tetraglyme (G4) ([Li(G4)]BETI), lithium cyano (trifluoromethanesulfonyl)imide salt and diglyme (G2) ([Li(G2)]CTFSI), lithium cyano (trifluoromethanesulfonyl)imide salt and triglyme (G3) ([Li(G3)]CTFSI), lithium cyano (trifluoromethanesulfonyl)imide salt and tetraglyme (G4) ([Li(G4)]CTFSI), lithium perchlorate salt and diglyme (G2) ([Li(G2)]ClO₄), lithium perchlorate salt and triglyme (G3) ([Li(G3)]ClO₄), lithium perchlorate salt and tetraglyme (G4) ([Li(G4)]ClO₄), lithium tetrafluoroborate salt and diglyme (G2) ([Li(G2)]BF₄), lithium tetrafluoroborate salt and triglyme (G3) ([Li(G3)]BF₄), lithium tetrafluoroborate salt and tetraglyme (G4) ([Li(G4)]BF₄), lithium nitrate salt and diglyme (G2) ([Li(G2)]NO₃), lithium nitrate salt and triglyme (G3) ([Li(G3)]NO₃), lithium nitrate salt and tetraglyme (G4) ([Li(G4)]NO₃), lithium triflate salt and diglyme (G2) ([Li(G2)]OTf), lithium triflate salt and triglyme (G3) ([Li(G3)]OTf), lithium triflate salt and tetraglyme (G4) ([Li(G4)]OTf), lithium trifluoroacetate salt and diglyme (G2) ([Li(G2)]TFA), lithium trifluoroacetate salt and triglyme (G3) ([Li(G3)]TFA), lithium trifluoroacetate salt and tetraglyme (G4) ([Li(G4)]TFA), or a combination thereof.

The liquid electrolyte may include a lithium salt and an ionic liquid including 1-ethyl-3-methylimidazolium bis(trifluoromethylsulfonyl)imide (EMIM-TFSI), 1-butyl-3-methylimidazolium bis(trifluoromethylsulfonyl)imide (BMIM-TFSI), N-propyl-N-methylpyrrolidinium bis(trifluoromethanesulfonyl)imide (PYR13TFSI), 1-butyl-1-methylpyrrolidinium bis(trifluoromethylsulfonyl)imide (PYR14TFSI), 1-ethyl-3-methylimidazolium bis(fluorosulfonyl)imide (EMIM-FSI), 1-butyl-3-methylimidazolium bis(fluorosulfonyl)imide (BMIM-FSI), N-propyl-N-methylpyrrolidinium bis(fluorosulfonyl)imide (PYR13-FSI), 1-butyl-1-methylpyrrolidinium bis(fluorosulfonyl)imide (PYR14-FSI), or a combination thereof.

The liquid electrolyte may include an organic solvent including ethylene carbonate (EC), propylene carbonate (PC), butylene carbonate (BC), fluoroethylene carbonate (FEC), dimethyl carbonate (DMC), diethyl carbonate (DEC), ethyl methyl carbonate (EMC), methyl formate, methyl acetate, methyl propionate, γ-butyrolactone, γ-valerolactone, 1,1,2,2-tetrafluoroethyl-2,2,3,3-tetrafluoropropyl ether (TTE), bis(2,2,2-trifluoroethyl) carbonate (ETFEC), bis(2,2,2-trifluoroethyl) ether (BTFE), 1,1,2,3,3,3-hexafluoropropyl-2,2,2-trifluoroethyl ether, methyl 3,3,3-trifluoropionate, or ethyl trifluoroacetate, tris(2,2,2-trifluoroethyl) orthoformate (TFEO), bis(2,2,2-trifluoroethyl) carbonate) (BTC), methyl 2,2,2-trifluoroethyl carbonate (FEMC), 1,2-dimethoxyethane (DME), 1-2-diethoxyethane, ethoxymethoxyethane, tetrahydrofuran, 2-methyltetrahydrofuran, 1,3-dioxolane (DOL), sulfolane, diglyme (G2), triglyme (G3), tetraglyme (G4), or a combination thereof; and a lithium salt including lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium difluorooxalatoborate (LiBF₂(C₂O₄)) (LiODFB), lithium tetraphenylborate (LiB(C₆H₅)₄), lithium bis-(oxalate) borate (LiB(C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LiFSI), lithium fluoroalkylphosphate (LiFAP) (Li₃O₄P), or a combination thereof.

The cathode 20 may include a first electrically conductive material. For example, the sulfuric conversion electroactive material 22 may be intermingled with the first electrically conductive material that provides an electron conduction path. The first electrically conductive material may be present in the cathode 20 in an amount from 1 wt. % to 20 wt. %, 1 wt. % to 15 wt. %, or 1 wt. % to 10 wt. %, based on total weight of the cathode 20. Inclusion of the disclosed solid state electrolyte may decrease the amount of first electrically conductive material that may otherwise be included in the cathode.

Examples of the first electrically conductive material include, for example, carbon black (such as, Super P), graphite, acetylene black (such as KETCHEN™ black or DENKA™ black), carbon nanotubes, carbon fibers, carbon nanofibers, graphene, graphene nanoplatelets, graphene oxide, nitrogen-doped carbon, metallic powder (e.g., copper, nickel, steel or iron), a liquid metal (e.g., Ga, GaInSn), a conductive polymer (e.g., include polyaniline, polythiophene, polyacetylene, polypyrrole, and the like), or a combination thereof. As used herein, the term “graphene nanoplatelet” refers to a nanoplate or stack of graphene layers. Such first electrically conductive material in particle form may have a round geometry or an axial geometry.

The term “axial geometry” refers to particles generally having a rod, fibrous, or otherwise cylindrical shape having an evident long or elongated axis. An aspect ratio (AR) for cylindrical shapes (e.g., a fiber or rod) may be defined as AR=L/D where L is the length of the longest axis and D is the diameter of the cylinder or fiber. Exemplary axial-geometry electroactive material particles suitable for use in the present disclosure may have high aspect ratios, ranging from 10 to 5,000, for example. The sulfuric conversion electroactive material particles having an axial-geometry include fibers, wires, flakes, whiskers, filaments, tubes, rods, and the like. The term “round geometry” typically applies to particles having lower aspect ratios, for example, an aspect ratio closer to 1 (e.g., less than 10). It should be noted that the particle geometry may vary from a true round shape and, for example, may include oblong or oval shapes, including prolate or oblate spheroids, agglomerated particles, polygonal (e.g., hexagonal) particles or other shapes that generally have a low aspect ratio. Oblate spheroids may have disc shapes that have relatively high aspect ratios. Thus, a generally round geometry particle is not limited to relatively low aspect ratios and spherical shapes.

The sulfuric conversion electroactive material 22 may be intermingled with a first binder 29 that improves the structural integrity of the cathode 20. The first binder 29 may be present in the cathode 20 in an amount from 1 wt. % to 20 wt. %, 1 wt. % to 15 wt. %, or 1 wt. % to 10 wt. %, based on total weight of the cathode 20.

The binder may include styrene-butadiene rubber (SBR), hydrogenated nitrile rubber (HNBR), poly(vinylidene fluoride) (PVDF), poly(vinylidene fluoride-co-hexafluoropropylene) (PVDF-HFP), polytetrafluoroethylene (PTFE), poly(tetrafluoroethylene-co-perfluoro (3-oxa-4-pentenesulfonic acid)) lithium salt, sodium carboxymethyl cellulose (CMC), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), or a combination thereof.

Without wishing to be bound by any theory, it is believed that by including the disclosed solid state electrolyte in a sulfur cathode, performance is enhanced by lowering cell impedance, increasing active material utilization by providing more reaction sites for sulfur redox reaction, and increasing cathode ion transport and kinetics. An electrochemical cell including a cathode including a sulfuric conversion electroactive material and an electrolytic material including a solvate ionic liquid (e.g., a limited solvating electrolyte) can exhibit desirable specific capacity, for example, 1 to 5 milliampere-hours per square centimeter (mAh/cm²). The solid state electrolyte may help achieve improved kinetics and energy densities.

An electrochemical cell including a cathode including a solid state electrolyte and an electrolytic material including an organic solvent and a lithium salt (e.g., a high solvating electrolyte) can exhibit desirable properties with a decreased electrolyte-to-sulfur volume ratio of less than 8:1. A decreased amount of such electrolyte may be desirable.

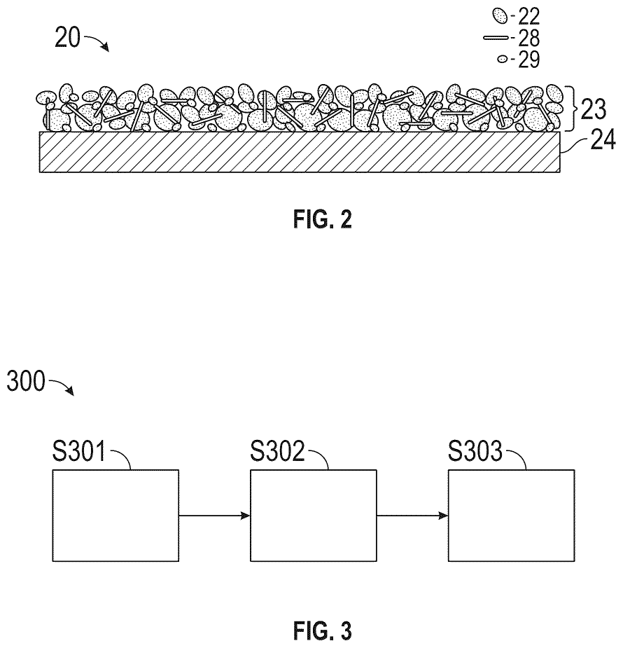

FIG. 2 schematically illustrates an embodiment of the cathode 20, which includes the cathode current collector 24 having a first electroactive material layer 23 thereon, after drying a sulfuric conversion electroactive material slurry. In an embodiment and as shown, the first electroactive material layer 23 may be applied onto one side of the cathode current collector 24. The first electroactive material layer 23 may be applied onto both sides of the cathode current collector 24. The first electroactive material layer 23 may include 30 wt. % to 70 wt. %, for example, 40 wt. % to 70 wt. %, of the sulfuric conversion electroactive material 22, 5 wt. % to 50 wt. %, for example, 5 wt. % to 30 wt. %, of the solid state electrolyte, 0.1 wt. % to 20 wt. % of the first binder, and 0.1 wt. % to 30 wt. % of the first electrically conductive material.

In an embodiment, the first electroactive material layer 23 may have a thickness between 30 μm and 300 μm. In an embodiment, the first electroactive material layer 23 may have a thickness between, for example, 35 μm and 150 μm.

The sulfuric conversion electroactive material slurry includes a mixture of the sulfuric conversion electroactive material 22, the solid state electrolyte 28, first binder 29, optional first electrically conductive material, and a solvent. The sulfuric conversion electroactive material 22 may have a maximum particle size of 100 μm and minimum particle size of 100 nm.

The first binder 29 may serve as a binding material to join the sulfuric conversion electroactive material 22, the solid state electrolyte 28, optional electrically conductive material, and the cathode current collector 24. The first binder 29 may be in the form of a powder, a resin, or dissolved in the solvent.

The mixture of the sulfuric conversion electroactive material 22, the solid state electrolyte 28, the first binder 29 that forms the first electroactive material layer 23, and the optional first electrically conductive material is formed into the sulfuric conversion electroactive material slurry employing an organic solvent or water by mixing, as illustrated by Step S301 of process 300 of FIG. 3. The sulfuric conversion electroactive material slurry including the first electroactive material layer 23 may be applied (e.g., cast) onto the cathode current collector 24, as illustrated by Step S302 of process 300 of FIG. 3, and dried to form a cathode.

The first electroactive material layer 23 may be applied onto the cathode current collector 24 by gravure coating, slot die coating, or dip coating in an embodiment. Slot-die coating is a deposition technique in which the sulfuric conversion electroactive material 22 slurry is delivered onto the substrate of the cathode current collector 24 via a narrow slot positioned close to the surface. A major advantage of the slot-die coating method is the simple relationship between wet-film coating thickness, the flow rate of solution, and the speed of the coated substrate relative to the head. In addition, slot-die coating is capable of achieving extremely uniform films across large areas. Slot-die coating is one of many methods that may be used to deposit a thin liquid film onto the surface of a substrate. One of the main advantages of slot-die coating is that it may easily be integrated into scale-up processes including roll-to-roll coating and sheet-to-sheet deposition systems.

The sulfuric conversion electroactive material slurry including the first electroactive material layer 23 may be applied onto the cathode current collector 24 by dipping the cathode current collector 24 into a bath including the sulfuric conversion electroactive material slurry in an embodiment.

The cathode current collector 24 having the first electroactive material layer 23 applied thereon is subjected to a drying process to bind the first electroactive material layer 23 onto the surface of the cathode current collector 24 to form the cathode 20, as illustrated by Step S303 of process 300 of FIG. 3. The drying process may include subjecting the cathode current collector 24 with the applied first electroactive material layer 23 to an elevated temperature environment for a period of time to remove the solvent, which may include subjecting the cathode current collector 24 with the applied first electroactive material layer 23 to a calendering process to improve adhesion of the first electroactive material layer 23 onto the surface of the cathode current collector 24. The cathode current collector 24 with the applied first electroactive material layer 23 is subjected to a temperature between 60° C. and 150° C. for a period of 1 to 60 minutes to dry and remove the solvent after binding the first electroactive material layer 23 onto the surface of the cathode current collector 24.

Accordingly, a wet process for forming the cathode may include mixing the sulfuric conversion electroactive material, the disclosed solid state electrolyte, and the first binder in a solvent to form a slurry: casting the slurry on a current collector; and drying the slurry to form the electrode including the disclosed solid state electrolyte. The solvent may include toluene, an alkane, anisole, an organic phosphate, or a combination thereof.

And a dry process for forming the cathode may include dry mixing the sulfuric conversion electroactive material, the disclosed solid state electrolyte, and the first binder to form a mixture; coating the mixture on a current collector to form a coated current collector; and calendaring the coated current collector to form the electrode including the disclosed solid state electrolyte. The mixing may include double blade milling, ball milling, using a circulating blending hybridizer, or a combination thereof. Coating the mixture on a current collector may include dry coating, dry spraying, hot pressing and melting extrusion, three-dimensional printing, or a combination thereof. The calendaring may include a pressure of 20 to 500 megapascals.

The anode may be in the form of a layer having a thickness from 1 μm to 1,000 μm, for example, from 5 μm to 400 μm or from 10 μm to 300 μm. The anode may be defined by a plurality of second electroactive material, for example, including the second electroactive material. The second electroactive material may have an average particle diameter from 0.01 μm to 50 μm, for example, from 1 μm to 20 μm.

An electroactive material layer of the anode may include second electroactive material, a second electrically conductive material, and a second binder. The anode may include, based on total weight of the anode, 30 wt. % to 100 wt. % of the second electroactive material, 0 wt. % to 30 wt. % of the second electrically conductive material, 0 wt. % to 20 wt. % of the second binder, and 0 wt. % to 30 wt. % of electrolytic material.

The anode includes a second electroactive material as a lithium host material capable of functioning as a negative terminal of a lithium ion battery. For example, the anode may include a lithium host material (e.g., second electroactive material) that is capable of functioning as a negative terminal of the battery cell. The anode may be defined by a plurality of second electroactive material particles.

The anode may include a second electroactive material including lithium, for example, lithium metal, a lithium alloy (such as, for example, a lithium silicon alloy, a lithium aluminum alloy, a lithium indium alloy, a lithium tin alloy, or a combination thereof), or a combination thereof. The anode may further include silicon, tin oxide, aluminum, indium, zinc, germanium, silicon oxide, titanium oxide, lithium titanate, iron sulfide (FeS), Li₄Ti₅O₁₂, or a combination thereof, for example, silicon mixed with graphite. The anode may be lithium metal itself. In an

The second electroactive material may be present in the anode in an amount from 70 wt. % to 100 wt. %, 70 wt. % to 98 wt. %, 70 wt. % to 95 wt. %, 80 wt. % to 95 wt. %, based on total weight of the anode.

The anode may include a second electrically conductive material. For example, the second electroactive material may be intermingled with the second electrically conductive material that provides an electron conduction path. The second electrically conductive material may be present in the anode in an amount from 0 wt. % to 30 wt. %, 1 wt. % to 25 wt. %, 1 wt. % to 20 wt. %, 1 wt. % to 10 wt. %, 3 wt. % to 20 wt. %, or 5 wt. % to 15 wt. %, based on total weight of the anode.

The second electrically conductive material may be the same as or different from the first electrically conductive material and may include, for example, carbon black (such as, Super P), graphite, acetylene black (such as KETCHEN™ black or DENKA™ black), carbon nanotubes, carbon fibers, carbon nanofibers, graphene, graphene nanoplatelets, graphene oxide, nitrogen-doped carbon, metallic powder (e.g., copper, nickel, steel or iron), a liquid metal (e.g., Ga, GaInSn), a conductive polymer (e.g., include polyaniline, polythiophene, polyacetylene, polypyrrole, and the like), or a combination thereof.

The anode may include a second binder. For example, the second electroactive material may be intermingled with a second binder that improves the structural integrity of the anode. The second binder may be present in the anode in an amount from 0 wt. % to 30 wt. %, 1 wt. % to 25 wt. %, 1 wt. % to 20 wt. %, 1 wt. % to 10 wt. %, 3 wt. % to 20 wt. %, or 5 wt. % to 15 wt. %, based on total weight of the anode. The second binder may include, for example, PTFE, sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), or a combination thereof.

The separator may have a thickness that may be between 10 μm to 50 μm. The separator may include a porous polymer (e.g., polyolefin) that provides thermal stability. With the disclosed use of a sulfuric conversion electroactive material and a limited solvating liquid electrolyte (e.g., an electrolyte that does not dissolve a sulfur cathode), a porous separator can be used.

Examples of a polyolefin include polyethylene (PE) (along with variations such as high density polyethylene (HDPE), low density polyethylene (LDPE), linear low density polyethylene (LLDPE), and ultra high molecular weight polyethylene (UHMWPE)), polypropylene (PP), and a blend of PE and PP. The polymer may electrically insulate and physically separate the cathode and the anode.

The separator may be a solid polymer electrolytic material that includes a polymer-such as polyethylene oxide (PEO), polypropylene oxide (PPO), polyacrylonitrile (PAN), a solid electrolytic material (e.g., an oxide-based electrolytic material or a sulfide-based electrolytic material), or a gel polymer electrolytic material having a lithium salt or swollen with a lithium salt solution. The cathode and the anode reversibly exchange lithium ions through the separator during applicable discharge and charge cycles.

The separator may include, for example, a microporous polymeric separator including a polyolefin or polytetrafluoroethylene (PTFE). The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. The polyolefin may be polyethylene (PE), polypropylene (PP), or a blend of PE and PP, or multi-layered structured porous films of PE, PP, or a combination thereof, for example, a PP-PE dual layer structure or PP-PE-PP three-layer structure. Commercially available polyolefin porous separator membranes include CELGARD® 2500 (a monolayer polypropylene separator) and CELGARD® 2325 (a trilayer polypropylene/polyethylene/polypropylene separator) available from Celgard LLC.

When the separator is a microporous polymeric separator, it may be a single layer or a multi-layer laminate, which may be fabricated from either a dry or a wet process. For example, in certain instances, a single layer of the polyolefin may form the entire separator. The separator may be a fibrous membrane having an abundance of pores extending between the opposing surfaces and may have an average thickness of less than a millimeter, for example. Multiple discrete layers of similar or dissimilar polyolefins may be assembled to form the microporous polymer separator. The separator may include polymers in addition to polyolefin such as, for example, polyethylene terephthalate (PET), polyvinylidene fluoride (PVDF), a polyamide, polyimide, poly(amide-imide) copolymer, polyetherimide, cellulose, or a combination thereof, or any suitable material for creating the desired porous structure. The separator may include a cellulose separator, a PVDF membrane, and a porous polyimide membrane.

The separator may include high temperature stable polymer, such as, for example, polyimide nanofiber-based nonwovens, nano-sized Al₂O₃ and poly(lithium 4-styrenesulfonate)-coated polyethylene membrane, SiO₂ coated polyethylene, co-polyimide-coated polyethylene, polyetherimides (PEI) bisphenol-acetone diphthalic anhydride (BPADA) and para-phenylenediamine, expanded poly tetrafluoroethylene reinforced polyvinylidenefluoride-hexafluoropropylene, and so on. The separator may be high temperature stable separator and include a sandwich-structured PVDF/poly(m-phenylene isophthalamide) (PMIA)/PVDF nanofibrous separator.

The separator may include a ceramic coating, a heat-resistant material coating, or a combination thereof. The ceramic coating, the heat-resistant material coating, or a combination thereof may be disposed on one or more sides of the separator. The material forming the ceramic coating may be alumina (Al₂O₃), silica (SiO₂), titania (TiO₂), or a combination thereof. The heat-resistant material may be, for example, Nomex, Aramid, or a combination thereof. The polymer (e.g., polyolefin) may be included in the separator as a fibrous layer to help provide the separator with appropriate structural and porosity characteristics.

The separator may be infiltrated with a liquid electrolytic material throughout the porosity of the polymer. The liquid electrolytic material, which wets both the cathode and the anode, may include a lithium salt dissolved in a non-aqueous solvent. The liquid electrolytic material may wet (e.g., fill, 5% to 100%, for example, 90%, of the porosity of) the separator.

The cathode, the anode, and the separator may each include the electrolytic material, for example, inside pores thereof, capable of conducting lithium ions between the anode and the cathode. Any appropriate electrolytic material, whether in solid, liquid, or gel form, capable of conducting lithium ions between the electrodes may be used in the battery cell. For example, the electrolytic material may be a non-aqueous liquid electrolyte solution that includes a lithium salt dissolved in an organic solvent or a mixture of organic solvents.

Appropriate lithium salts may have inert anions. Exemplary lithium salts that may be dissolved in an organic solvent or a mixture of organic solvents to form a non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium difluorooxalatoborate (LiBF₂ (C₂O₄)) (LiODFB), lithium tetraphenylborate (LiB(C₆H₅)₄), lithium bis-(oxalate) borate (LiB(C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LiFSI), lithium fluoroalkylphosphate (LiFAP) (Li₃O₄P), or a combination thereof.

The lithium salt may be dissolved in a variety of organic solvents, including, for example, an alkyl carbonate, such as a cyclic carbonate (e.g., ethylene carbonate (EC), propylene carbonate (PC), butylene carbonate (BC), fluoroethylene carbonate (FEC)), a linear carbonate (e.g., dimethyl carbonate (DMC), diethyl carbonate (DEC), ethyl methyl carbonate (EMC)), an aliphatic carboxylic ester (e.g., methyl formate, methyl acetate, methyl propionate), a γ-lactone (e.g., γ-butyrolactone, γ-valerolactone), fluorinated ether (e.g., 1,1,2,2-tetrafluoroethyl-2,2,3,3-tetrafluoropropyl ether (TTE), bis(2,2,2-trifluoroethyl) ether (BTFE), tris(2,2,2-trifluoroethyl) orthoformate (TFEO), fluorinated ester (e.g., ethyl 2,2,2-trifluoroethyl carbonate (ETFEC), bis(2,2,2-trifluoroethyl) carbonate (BTC), methyl 2,2,2-trifluoroethyl carbonate (FEMC)), a chain structure ether (e.g., 1,2-dimethoxyethane (DME), 1-2-diethoxyethane, ethoxymethoxyethane), a cyclic ether (e.g., tetrahydrofuran, 2-methyltetrahydrofuran, 1,3-dioxolane (DOL)), a sulfur compound (e.g., sulfolane), 1-ethyl-3-methylimidazolium bis(trifluoromethylsulfonyl)imide (EMIMTFSI), 1-butyl-3-methylimidazolium bis(trifluoromethylsulfonyl)imide (BMIM-TFSI), N-propyl-N-methylpyrrolidinium bis(trifluoromethanesulfonyl)imide (PYR13TFSI), 1-butyl-1-methylpyrrolidinium bis(trifluoromethylsulfonyl)imide (PYR14TFSI), 1-ethyl-3-methylimidazolium bis(fluorosulfonyl)imide (EMIM-FSI), 1-butyl-3-methylimidazolium bis(fluorosulfonyl)imide (BMIM-FSI), N-propyl-N-methylpyrrolidinium bis(fluorosulfonyl)imide (PYR13-FSI), 1butyl1methylpyrrolidinium bis(fluorosulfonyl)imide (PYR14-FSI), or a combination thereof. The electrolytic material may include from 0.5 moles per liter (molar (M)) to 9.0 M or 0.5 M to 4.0 M of the one or more lithium salts. When the electrolytic material has a lithium concentration greater than 2 M or ionic liquids, the electrolytic material may include fluoroethylene carbonate (FEC), hydrofluoroether (HFE), or a combination thereof.

The electrolytic material, for example, a solid state electrolyte, may serve as both a conductor of lithium ions and a separator, such that a distinct separator component may not be present. Solid state electrolyte particles may include oxide-based particles, sulfide-based particles, metal-doped or aliovalent-substituted oxide particles, inactive oxide particles, nitride-based particles, hydride-based particles, halide-based particles, borate-based particles, or a combination thereof.

The oxide-based particles may include a garnet ceramic, a LISICON-type oxide, a NASICON-type oxide, a Perovskite type ceramic, or a combination thereof. For example, the garnet ceramic may be Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, or a combination thereof. The LISICON-type oxide may be Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), or a combination thereof. The NASICON-type oxide may be defined by LiMM′(PO₄)₃, where M and M′ are independently Al, Ge, Ti, Sn, Hf, Zr, or La. For example, the NASICON-type oxide may be Li₁₊ₓAlₓGe₂₋ₓ(PO₄)₃ (LAGP) (where 0≤x≤2), Li_{1.4}Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, or a combination thereof. The Perovskite-type ceramic may be Li_{3.3}La_{0.53}TiO₃, LiSr_{1.65}Zr_{1.3}Ta_{1.7}O₉, Li_{2xy}Sr₁ₓTa_{y}Zr_{1y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), or a combination thereof.

The metal-doped or aliovalent-substituted oxide particles may include, for example, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) vanadium (V) substituted LiSn₂P₃O₁₂, aluminum (Al) substituted Li_{1+x+y}AlₓTi₂₋ₓSi_{y}P_{3-y}O₁₂ (where 0<x<2 and 0<y<3), or a combination thereof.

The sulfide-based particles may include, for example, a pseudobinary sulfide, a pseudoternary sulfide, a pseudoquaternary sulfide, or a combination thereof. Example pseudobinary sulfide systems include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ systems, Li₂S—P₂S₃ systems, Li₂S—Al₂S₃ systems, Li_{3.4}Si_{0.4}P_{0.6}S₄, Li₁₀GeP₂S_{11.7}O_{0.3}, lithium argyrodites Li₆PS₅X (where X is one of Cl, Br, and I). Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ (thio-LISICON) and Li₁₀GeP₂S₁₂ (LGPS)), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4LiI·0.6Li₄SnS₄, and Li₁₁Si₂PS₁₂. Example pseudoquaternary sulfide systems include Li₂O—Li₂S—P₂S₅—P₂O₅ systems, Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.1.9}S₁₂, Li₁₀(Si_{0.5}Ge_{0.5})P₂S₁₂, Li₁₀(Ge_{0.5}Sne_{0.5})P₂S₁₂, Li₁₀(Si_{0.5}Sn_{0.5})P₂S₁₂, Li₇P_{2.9}Mn_{0.1}S_{10.7}I_{0.3}, Li_{3.833}Sn_{0.833}As_{0.166}S₄, LiI—Li₄SnS₄, Li₄SnS₄, and Li_{10.35}[Sn_{0.27}Si_{1.08}]P_{1.65}S₁₂.

The inactive oxide particles may include, for example, SiO₂, Al₂O₃, TiO₂, ZrO₂, or a combination thereof; the nitride-based particles may include, for example, Li₃N, Li₇PN₄, LiSi₂N₃, or a combination thereof; the hydride-based particles may include, for example, LiBH₄, LiBH₄—LiX (where X=Cl, Br, or I), LiNH₂, Li₂NH, LiBH₄—LiNH₂, Li₃AlH₆, or a combination thereof; the halide-based particles may include, for example, LiI, Li₃InCl₆, Li₂CdCl₄, Li₂MgCl₄, LiCdI₄, Li₂ZnI₄, Li₃OCl, Li₃YCl₆, Li₃YBr₆, or a combination thereof; and the borate-based particles may include, for example, Li₂B₄O₇, Li₂O—B₂O₃—P₂O₅, or a combination thereof.

The descriptions set forth herein pertaining to the cathode, the anode, the separator, and the electrolytic material are intended to be non-limiting examples. Many variations on the chemistry of each of the elements may be applied in the context of the lithium ion battery cell of the present disclosure.

### EXAMPLES

### Comparative Example 1

A coin cell was fabricated with a cathode made from a slurry including 60 to 98 weight percent (wt. %) of a sulfur-carbon composite (including 50 to 95 wt. % sulfur and 5 to 50 wt. % carbon), 1 to 20 wt. % binder, and 1 to 20 wt. % electrically conductive material cast at a loading of 1 milligram per square centimeter (mg/cm²) on an aluminum current collector. The anode was a chip of lithium metal and an Entek nanoparticle fused polyethylene separator and lithium bis(trifluoromethanesulfonyl)imide salt and tetraglyme (G4) (Li(G4)TFSI) as electrolyte were used.

### Example 1

A coin cell was fabricated with a cathode made from a slurry including 80 weight percent (wt. %) sulfur in 20 wt. % Ketjen black, 70Li₂S·25P₂S₅·5P₂O₅ solid state electrolyte, Super P conductive carbon, and hydrogenated nitrile rubber (HNBR), binder in a weight ratio of 60:20:10:10 cast at a loading of 1 milligram per square centimeter (mg/cm²) on an aluminum current collector. The anode was a chip of lithium metal and an Entek nanoparticle fused polyethylene separator and lithium bis(trifluoromethanesulfonyl)imide salt and tetraglyme (G4) (Li(G4)TFSI) as electrolyte were used.

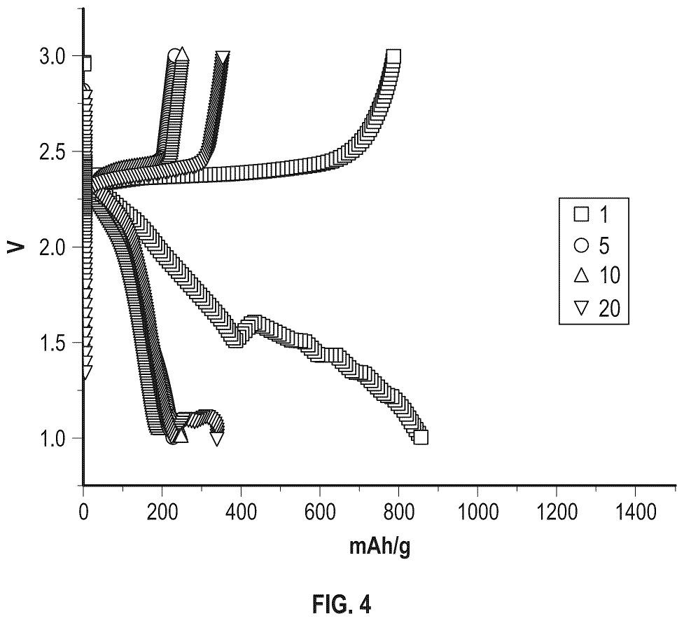

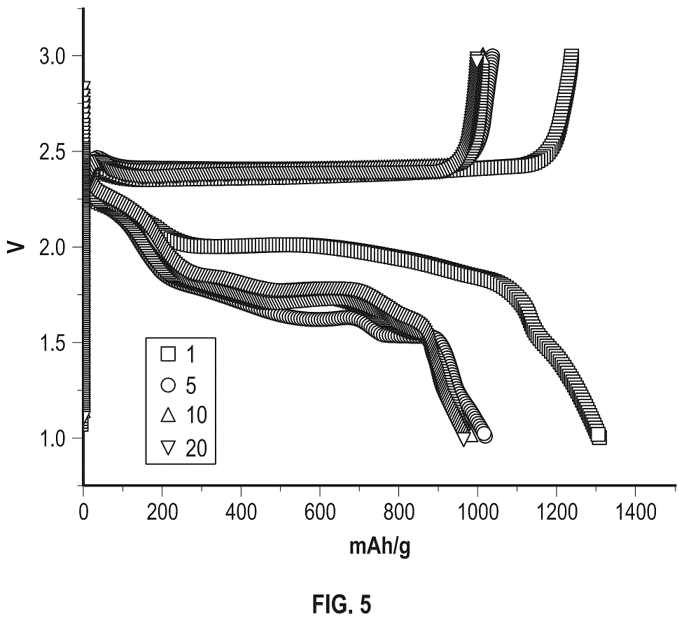

FIG. 4 is a graph of voltage (volts (V)) versus specific capacity (milliampere-hours per gram (mAh/g)) for Comparative Example 1 and FIG. 5 is a graph of voltage (V) versus specific capacity (mAh/g) for Example 1, in which “1” refers to cycle 1, “5” refers to cycle 5, “10” refers to cycle 10, and “20” refers to cycle 20. Testing included C/20 in first cycle and C/10 for later cycles. As seen by comparing FIG. 4 with FIG. 5, higher specific capacity with good cycle stability may be achieved using the disclosed solid state electrolyte. The higher plateau of FIG. 4 as compared to FIG. 5 means lower impedance and lower overpotential. {Please confirm: any other comments to include?}

Without wishing to be bound by any theory, it is believed that the disclosed solid state electrolyte may improve Li-ion conductivity by providing more Li-ion pathway(s). The disclosed solid state electrolyte may also provide reaction sites for S redox reaction.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electrochemical cell comprising:
an electrode comprising
a sulfuric conversion electroactive material, and
a solid state electrolyte comprising an oxysulfide;
a liquid electrolyte;
a separator; and
a negative electrode.

2. The electrochemical cell of claim 1, wherein:
the solid state electrolyte comprises 75Li₂S—20P₂S₅-5P₂O₅; and
the liquid electrolyte comprises
lithium bis(trifluoromethanesulfonyl)imide salt and triglyme (G3) (Li(G3)TFSI), or
lithium bis(trifluoromethanesulfonyl)imide salt and tetraglyme (G4) (Li(G4)TFSI), wherein a molar ratio of salt to solvent is 1:0.8.

3. The electrochemical cell of claim 1, wherein the liquid electrolyte comprises a limited solvating liquid electrolyte.

4. The electrochemical cell of claim 3, wherein the separator comprises a porous polymer separator.

5. The electrochemical cell of claim 1, wherein the sulfuric conversion electroactive material comprises S, S₅, Li₂S₈, Li₂S₆, Li₂S₄, Li₂S₂, Li₂S, Fe₂S, or a combination thereof.

6. The electrochemical cell of claim 1, wherein the solid state electrolyte comprises yLi₂S·(100-y-x)P₂S₅·XP₂O₅, wherein y is in a range from 70 molar percentage to 80 molar percentage and x is in a range from 0.5 molar percentage to 10 molar percentage.

7. The electrochemical cell of claim 1, wherein the solid state electrolyte comprises Li₁₀MP₂S₁₂, wherein M is Si, Ge, or Sn; Li₆PS₅Cl; Li_{3.25}Ge_{0.25}P_{0.75}S₄;
Li₄GeS₄; a Li₂S—P₂S₅ system; a Li₂S—SnS₂ system; a Li₂S—SiS₂ system; a Li₂S—GeS₂ system; a Li₂S—B₂S₃ system; a Li₂S—Ga₂S₃ system; a Li₂S—P₂S₃ system; a Li₂S—Al₂S₃ system; Li_{3.4}Si_{0.4}P_{0.6}S₄; Li₁₀GeP₂S_{11.7}O_{0.3}; a lithium argyrodite Li₆PS₅X where X is Cl, Br, or I; a Li₂O—Li₂S—P₂S₅ system; a Li₂S—P₂S₅—P₂O₅ system; a Li₂S—P₂S₅—GeS₂ system; a Li₂S—P₂S₅—LiX system where X is F, Cl, Br, or I; a Li₂S—As₂S₅—SnS₂ system; a Li₂S—P₂S₅—Al₂S₃ system; a Li₂S—LiX—SiS₂ system where X is or F, Cl, Br, and I; 0.4LiI·0.6Li₄SnS₄; Li₁₁Si₂PS₁₂; a Li₂O—Li₂S—P₂S₅—P₂O₅ system; Li_{9.54}S_{11.74}P_{1.44}S_{11.7}Cl_{0.3}; Li_{9.6}P₃S₁₂; Li₇P₃S₁₁; Li₉P₃S₉O₃; Li_{10.35}Ge_{1.35}P_{1.65}S₁₂; Li_{10.35}Si_{1.35}P_{1.65}S₁₂; Li_{9.81}Sn_{0.81}P_{2.1.9}S₁₂; Li₁₀(Si_{0.5}Ge_{0.5})P₂S₁₂; Li₁₀(Ge_{0.5}Sne_{0.5})P₂S₁₂; Li₁₀(Si_{0.5}Sn_{0.5})P₂S₁₂; Li₇P_{2.9}Mn_{0.1}S_{10.7}I_{0.3}; Li_{3.833}Sn_{0.833}As_{0.166}S₄; LiI—Li₄SnS₄; Li₄SnS₄; Li_{10.35}[Sn_{0.27}Si_{1.08}]P_{1.65}S₁₂; or a combination thereof.

8. The electrochemical cell of claim 1, wherein the liquid electrolyte comprises a solvate ionic liquid comprising lithium bis(trifluoromethanesulfonyl)imide salt and diglyme (G2) (Li(G2)TFSI), lithium bis(trifluoromethanesulfonyl)imide salt and triglyme (G3) (Li(G3)TFSI), lithium bis(trifluoromethanesulfonyl)imide salt and tetraglyme (G4) (Li(G4)TFSI), lithium bis(fluorosulfonyl)imide salt and diglyme (G2) (Li(G2)FSI), lithium bis(fluorosulfonyl)imide salt and triglyme (G3) (Li(G3)FSI), lithium bis(fluorosulfonyl)imide salt and tetraglyme (G4) (Li(G4)FSI), lithium bis(pentafluoroethanesulfonyl)imide salt and diglyme (G2) ([Li(G2)]BETI), lithium bis(pentafluoroethanesulfonyl)imide salt and triglyme (G3) ([Li(G3)]BETI), lithium bis(pentafluoroethanesulfonyl)imide salt and tetraglyme (G4) ([Li(G4)]BETI), lithium cyano (trifluoromethanesulfonyl)imide salt and diglyme (G2) ([Li(G2)]CTFSI), lithium cyano (trifluoromethanesulfonyl)imide salt and triglyme (G3) ([Li(G3)]CTFSI), lithium cyano (trifluoromethanesulfonyl)imide salt and tetraglyme (G4) ([Li(G4)]CTFSI), lithium perchlorate salt and diglyme (G2) ([Li(G2)]ClO₄), lithium perchlorate salt and triglyme (G3) ([Li(G3)]ClO₄), lithium perchlorate salt and tetraglyme (G4) ([Li(G4)]ClO₄), lithium tetrafluoroborate salt and diglyme (G2) ([Li(G2)]BF₄), lithium tetrafluoroborate salt and triglyme (G3) ([Li(G3)]BF₄), lithium tetrafluoroborate salt and tetraglyme (G4) ([Li(G4)]BF₄), lithium nitrate salt and diglyme (G2) ([Li(G2)]NO₃), lithium nitrate salt and triglyme (G3) ([Li(G3)]NO₃), lithium nitrate salt and tetraglyme (G4) ([Li(G4)]NO₃), lithium triflate salt and diglyme (G2) ([Li(G2)]OTf), lithium triflate salt and triglyme (G3) ([Li(G3)]OTf), lithium triflate salt and tetraglyme (G4) ([Li(G4)]OTf), lithium trifluoroacetate salt and diglyme (G2) ([Li(G2)]TFA), lithium trifluoroacetate salt and triglyme (G3) ([Li(G3)]TFA), lithium trifluoroacetate salt and tetraglyme (G4) ([Li(G4)]TFA), or a combination thereof.

9. The electrochemical cell of claim 1, wherein the liquid electrolyte comprises an ionic liquid electrolyte comprising 1-ethyl-3-methylimidazolium bis(trifluoromethylsulfonyl)imide (EMIM-TFSI), 1-butyl-3-methylimidazolium bis(trifluoromethylsulfonyl)imide (BMIM-TFSI), N-propyl-N-methylpyrrolidinium bis(trifluoromethanesulfonyl)imide (PYR13TFSI), 1-butyl-1-methylpyrrolidinium bis(trifluoromethylsulfonyl)imide (PYR14TFSI), 1-ethyl-3-methylimidazolium bis(fluorosulfonyl)imide (EMIM-FSI), 1-butyl-3-methylimidazolium bis(fluorosulfonyl)imide (BMIM-FSI), N-propyl-N-methylpyrrolidinium bis(fluorosulfonyl)imide (PYR13-FSI), 1-butyl-1-methylpyrrolidinium bis(fluorosulfonyl)imide (PYR14-FSI), or a combination thereof.

10. The electrochemical cell of claim 1, wherein the liquid electrolyte comprises
an organic solvent comprising ethylene carbonate (EC), propylene carbonate (PC), butylene carbonate (BC), fluoroethylene carbonate (FEC), dimethyl carbonate (DMC), diethyl carbonate (DEC), ethyl methyl carbonate (EMC), methyl formate, methyl acetate, methyl propionate, γ-butyrolactone, γ-valerolactone, 1,1,2,2-tetrafluoroethyl-2,2,3,3-tetrafluoropropyl ether (TTE), bis(2,2,2-trifluoroethyl) carbonate (ETFEC), bis(2,2,2-trifluoroethyl) ether (BTFE), 1,1,2,3,3,3-hexafluoropropyl-2,2,2-trifluoroethyl ether, methyl 3,3,3-trifluoropionate, or ethyl trifluoroacetate, tris(2,2,2-trifluoroethyl) orthoformate (TFEO), bis(2,2,2-trifluoroethyl) carbonate) (BTC), methyl 2,2,2-trifluoroethyl carbonate (FEMC), 1,2-dimethoxyethane (DME), 1,2-diethoxyethane, ethoxymethoxyethane, tetrahydrofuran, 2-methyltetrahydrofuran, 1,3-dioxolane (DOL), sulfolane, diglyme (G2), triglyme (G3), tetraglyme (G4), or a combination thereof; and
a lithium salt comprising lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium difluorooxalatoborate (LiBF₂ (C₂O₄)) (LiODFB), lithium tetraphenylborate (LiB(C₆H₅)₄), lithium bis-(oxalate) borate (LiB(C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LiFSI), lithium fluoroalkylphosphate (LiFAP) (Li₃O₄P), or a combination thereof.

11. The electrochemical cell of claim 1, wherein the sulfuric conversion electroactive material comprises a sulfur-carbon composite, a Li₂S—C composite, sulfurized polyacrylonitrile, or a combination thereof.

12. The electrochemical cell of claim 1, wherein the electrode further comprises an electrically conductive material comprising carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, or a combination thereof.

13. The electrochemical cell of claim 1, wherein the electrode further comprises a binder comprising styrene-butadiene rubber (SBR), hydrogenated nitrile rubber (HNBR), poly(vinylidene fluoride) (PVDF), poly(vinylidene fluoride-co-hexafluoropropylene) (PVDF-HFP), polytetrafluoroethylene (PTFE), poly(tetrafluoroethylene-co-perfluoro (3-oxa-4-pentenesulfonic acid)) lithium salt, sodium carboxymethyl cellulose (CMC), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), or a combination thereof.

14. The electrochemical cell of claim 13, wherein the electrode comprises, based on a total weight of the electrode:
40 to 70 weight percent of the sulfuric conversion electroactive material;
5 to 30 weight percent of the solid state electrolyte;
0.1 to 20 weight percent of the binder; and
0.1 to 30 weight percent of an electrically conductive material.

15. The electrochemical cell of claim 1, wherein the negative electrode comprises lithium, graphite, graphene, hard carbon, soft carbon, carbon nanotubes, silicon, silicon-containing alloys, tin-containing alloys, or a combination thereof.

16. An electrochemical cell comprising:
an electrode comprising
a sulfuric conversion electroactive material, and
an oxide solid state electrolyte;
a liquid electrolyte;
a separator; and
a negative electrode.

17. The electrochemical cell of claim 16, wherein the liquid electrolyte comprises a limited solvating liquid electrolyte comprising a solvate ionic liquid.

18. The electrochemical cell of claim 16, wherein:
the oxide solid state electrolyte comprises
Li₁₊ₓAlₓGe₂₋ₓ(PO₄)₃ (LAGP) (where 0≤x≤2),
Li₇La₃Zr₂O₁₂ (LLZO), or
Li₁₊ₓAlₓTi₂₋ₓ(PO₄)₃ (LATP) (where 0≤x≤2); and
the liquid electrolyte comprises
lithium bis(trifluoromethanesulfonyl)imide salt and triglyme (G3) (Li(G3)TFSI), or
lithium bis(trifluoromethanesulfonyl)imide salt and tetraglyme (G4) (Li(G4)TFSI), wherein a molar ratio of salt to solvent is 1:0.8.

19. An electrochemical cell comprising:
an electrode comprising
a sulfuric conversion electroactive material, and
a solid state electrolyte comprising a sulfide;
a liquid electrolyte;
a separator; and
a negative electrode.

20. The electrochemical cell of claim 19, wherein the liquid electrolyte comprises a limited solvating liquid electrolyte comprising a solvate ionic liquid.
